(19) United States
(12) Patent Application Publication
(10) Pub. No.: US 2026/0155916 A1
(43) Pub. Date: Jun. 4, 2026

(54) RETRANSMISSION OF LAYER 2 HYBRID AUTOMATIC REPEAT REQUEST INDICATION

(71) Applicant: QUALCOMM Incorporated, San Diego, CA (US)

(72) Inventors: Kangqi LIU, San Diego, CA (US); Diana MAAMARI, San Diego, CA (US); Gabi SARKIS, San Diego, CA (US); Mostafa KHOSHNEVISAN, San Diego, CA (US); Jing SUN, San Diego, CA (US)

(21) Appl. No.: 18/966,870

(22) Filed: Dec. 3, 2024

(51) Int. Cl. H04L 1/1867; H04W 72/21

(52) U.S. Cl. CPC H04L 1/1896; H04W 72/21

(57) ABSTRACT

Various aspects of the present disclosure generally relate to wireless communication. In some aspects, a user equipment (UE) may transmit, to a network node, a Layer 2 (L2) hybrid automatic repeat request (HARQ) indication. The UE may receive, from the network node, a message indicating unsuccessful decoding of the L2 HARQ indication. The UE may retransmit, to the network node, the L2 HARQ indication based on the message indicating the unsuccessful decoding of the L2 HARQ indication. Numerous other aspects are described.

### FIELD OF THE DISCLOSURE

Aspects of the present disclosure generally relate to wireless communication and specifically relate to techniques, apparatuses, and methods associated with retransmission of layer 2 hybrid automatic repeat request indication.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs 5 are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to transmit, to a network node, a Layer 2 (L2) hybrid automatic repeat request (HARQ) indication. The one or more processors may be configured to receive, from the network node, a message indicating unsuccessful decoding of the L2 HARQ indication. The one or more processors may be configured to retransmit, to the network node, the L2 HARQ indication based on the message indicating the unsuccessful decoding of the L2 HARQ indication.

Some aspects described herein relate to a network node for wireless communication. The network node may include one or more memories and one or more processors coupled to the one or more memories. The one or more processors may be configured to receive, from a UE, an L2 HARQ indication. The one or more processors may be configured to transmit, to the UE, a message indicating unsuccessful decoding of the L2 HARQ indication. The one or more processors may be configured to receive, from the UE, a retransmission of the L2 HARQ indication.

Some aspects described herein relate to a method of wireless communication performed by a UE. The method may include transmitting, to a network node, an L2 HARQ indication. The method may include receiving, from the network node, a message indicating unsuccessful decoding of the L2 HARQ indication. The method may include retransmitting, to the network node, the L2 HARQ indication based on the message indicating the unsuccessful decoding of the L2 HARQ indication.

Some aspects described herein relate to a method of wireless communication performed by a network node. The method may include receiving, from a UE, an L2 HARQ indication. The method may include transmitting, to the UE, a message indicating unsuccessful decoding of the L2 HARQ indication. The method may include receiving, from the UE, a retransmission of the L2 HARQ indication.

Some aspects described herein relate to a non-transitory computer-readable medium that stores a set of instructions for wireless communication by a UE. The set of instructions, when executed by one or more processors of the UE, may cause the UE to transmit, to a network node, an L2 HARQ indication. The set of instructions, when executed by one or more processors of the UE, may cause the UE to receive, from the network node, a message indicating unsuccessful decoding of the L2 HARQ indication. The set of instructions, when executed by one or more processors of the UE, may cause the UE to retransmit, to the network node, the L2 HARQ indication based on the message indicating the unsuccessful decoding of the L2 HARQ indication.

Some aspects described herein relate to a non-transitory computer-readable medium that stores a set of instructions for wireless communication by a network node. The set of instructions, when executed by one or more processors of the network node, may cause the network node to receive, from a UE, an L2 HARQ indication. The set of instructions, when executed by one or more processors of the network node, may cause the network node to transmit, to the UE, a message indicating unsuccessful decoding of the L2 HARQ indication. The set of instructions, when executed by one or more processors of the network node, may cause the network node to receive, from the UE, a retransmission of the L2 HARQ indication.

Some aspects described herein relate to an apparatus for wireless communication. The apparatus may include means for transmitting, to a network node, an L2 HARQ indication. The apparatus may include means for receiving, from the network node, a message indicating unsuccessful decoding of the L2 HARQ indication. The apparatus may include means for retransmitting, to the network node, the L2 HARQ indication based on the message indicating the unsuccessful decoding of the L2 HARQ indication.

Some aspects described herein relate to an apparatus for wireless communication. The apparatus may include means for receiving, from a UE, an L2 HARQ indication. The apparatus may include means for transmitting, to the UE, a message indicating unsuccessful decoding of the L2 HARQ indication. The apparatus may include means for receiving, from the UE, a retransmission of the L2 HARQ indication.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a user plane protocol stack and a control plane protocol stack for a network node and a core network in communication with a user equipment (UE), in accordance with the present disclosure.

FIG. 4 is a diagram illustrating an example of a hybrid automatic repeat request (HARQ) protocol, in accordance with the present disclosure.

FIG. 5 is a diagram illustrating an example of physical uplink control channel formats, in accordance with the present disclosure.

FIG. 6 is a diagram illustrating examples of a HARQ acknowledgement (HARQ-ACK) codebook structure, in accordance with the present disclosure.

FIG. 7 is a diagram illustrating an example associated with retransmission of a layer 2 (L2) HARQ indication, in accordance with the present disclosure.

FIG. 8 is a diagram illustrating an example associated with retransmission of an L2 HARQ indication, in accordance with the present disclosure.

FIG. 9 is a diagram illustrating examples associated with retransmission of an L2 HARQ indication, in accordance with the present disclosure.

FIG. 10 is a diagram illustrating an example associated with retransmission of an L2 HARQ indication, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIGS. 13-14 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a hybrid automatic repeat request (HARQ) protocol is a reliability protocol in which a receiver (e.g., a user equipment (UE) or a network node) checks for errors in received data and, if an error is detected, then the receiver buffers the received data and/or requests a retransmission from a transmitter (e.g., a UE or a network node). The receiver may then be able to combine the buffered received data with retransmitted data, which improves performance of the retransmission. Additionally, or alternatively, the HARQ protocol may enable the receiver to request a retransmission in cases where a scheduled transmission is missed or otherwise not received, or to combine multiple repetitions of a data transmission without requesting a retransmission.

A HARQ acknowledgement (HARQ-ACK) system provides a mechanism for the receiver to provide feedback indicating whether certain transmissions have been received and/or correctly decoded by the receiver. For example, a UE may provide HARQ feedback indicating an ACK value when a transmission has been received and decoded by the UE, or the UE may provide HARQ feedback indicating a negative ACK (NACK) (e.g., a HARQ-NACK) value when the transmission was not received or was unsuccessfully decoded by the UE. In some examples, the UE may determine HARQ feedback using a HARQ codebook. For example, the UE may determine whether a set of transmissions were successfully received and/or decoded, may add ACKs or NACKs to the HARQ codebook in a particular order to indicate which transmissions of the set of transmissions were successfully received, and may generate HARQ feedback using the HARQ codebook. In some examples, where the network node indicates, to the UE, that the HARQ-ACK or HARQ-NACK was not successfully decoded, the UE may retransmit the respective HARQ-ACK or HARQ-NACK.

In some examples, a UE may send an initial transmission of and/or a retransmission of HARQ-ACK and/or HARQ-NACK feedback via a physical uplink control channel (PUCCH), which is an uplink physical channel that carries uplink control information (UCI). However, transmitting the HARQ-ACK and/or HARQ-NACK on a PUCCH involves a complicated implementation scheme, including numerous procedures to determine payload size, format, multiplexing rules, and/or location, as well as restrictions on payload size.

Various aspects relate generally to retransmitting, to a network node, a Layer 2 (L2) HARQ indication (e.g., HARQ-ACK or HARQ-NACK) based on a message from the network node indicating unsuccessful decoding of an L2 HARQ indication. Some aspects more specifically relate to carrying the L2 HARQ indication as a medium access control (MAC) control element (MAC-CE), which may be known as or referred to as HARQ MAC-CE. In some aspects, an L2 HARQ indication may be a HARQ MAC-CE, and a HARQ MAC-CE may be one example of an L2 HARQ indication. In some aspects, the L2 HARQ indication may be retransmitted in a physical uplink shared channel (PUSCH) based on receiving a message from the network node indicating unsuccessful decoding of the L2 HARQ indication at least a threshold time prior to the PUSCH transmission. In some aspects, the message indicating unsuccessful decoding of the L2 HARQ indication may include downlink feedback information (DFI) and/or downlink control information (DCI) scheduling a retransmission (e.g., indicating a HARQ process identifier (HARQ ID) with an untoggled new data indicator (NDI)). In some additional aspects, the L2 HARQ indication and a retransmission of an L2 service data unit (SDU) may be transmitted on one or more separate PUSCH resources according to a sequence indicator and/or to a priority indicator. In some aspects, an L2 HARQ indication and a retransmission of an L2 SDU may be multiplexed within a PUSCH resource, where encoding for uplink shared channel (UL-SCH) data may be separated from the encoding for the L2 HARQ indication. In some aspects, the L2 HARQ indication may be retransmitted in a payload combining a first codebook associated with the initial transmission of the L2 HARQ indication and a second codebook associated with a retransmission of the L2 HARQ indication. In some additional aspects, the first codebook associated with the initial transmission of the L2 HARQ indication and the second codebook associated with the retransmission of the L2 HARQ indication may be transmitted in separate PUSCH messages.

Particular aspects of the subject matter described in this disclosure can be implemented to realize one or more of the following potential advantages. In some examples, the described techniques can be used to simplify the HARQ-ACK protocol and increase the efficiency of resource allocation despite any potential increases in latency, relative to indicating HARQ feedback in a PUCCH. Additionally, carrying HARQ-ACK and/or HARQ-NACK feedback on L2 of a transmission protocol stack may simplify the HARQ-ACK system, which may reduce or eliminate different formats and/or multiplexing rules for the HARQ feedback. In some examples, by enabling an L2 HARQ indication and an L2 SDU to be transmitted according to a sequencing indicator or a priority indicator, the UE may adapt transmissions to network conditions and to available resources. For example, the scheduling indicator and/or the priority indicator may indicate a configuration based on the size of the L2 SDU and/or the L2 HARQ indication to efficiently utilize available resources in a transport block (TB) and increase spectral efficiency. Additionally, the L2 HARQ indication may be adapted to the PUSCH preparation capabilities of the UE, where the threshold time period enables an L2 HARQ indication to be scheduled in sufficient time to be transmitting in a PUSCH, thereby increasing efficiency in utilizing transmission resources. For example, where the UE receives an indication that the L2 HARQ indication was not successfully decoded at least a threshold time before the PUSCH transmission, the UE may include the retransmission of the L2 HARQ indication in a PUSCH, thereby increasing the utilization of available resources. Additionally, by transmitting the L2 HARQ indication and the L2 SDU together using separate encoding schemes, the UE may utilize uplink resources more efficiently and flexibly while permitting both the L2 HARQ indication and the L2 SDU to be transmitted within the same grant. For example, separating the L2 SDU (e.g., UL-SCH data) retransmission and the L2 HARQ indication (e.g., UCI) enables processing tailored for each type of information and may enable flexible allocation of resources between UL-SCH data and UCI. As an additional example, the UE may adapt to network conditions by adjusting resource allocation to balance data throughput and signaling reliability, where, for example, the L2 HARQ indication may require higher reliability and accuracy relative to the data retransmission. In some examples, by combining the initial L2 HARQ indication and the L2 HARQ indication retransmission in a new L2 HARQ payload, the larger payload size may improve channel coding gain, where, for example, the increased code block size may enable use of a higher order modulation scheme to increase spectral efficiency. Additionally, by combining the log likelihood ratio (LLR) of the initial L2 HARQ indication with the L2 HARQ indication retransmission, the transmission reliability of the L2 HARQ indication may be increased, enabling the use of an increased data rate and/or the balancing of throughput and accuracy dependent upon network conditions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

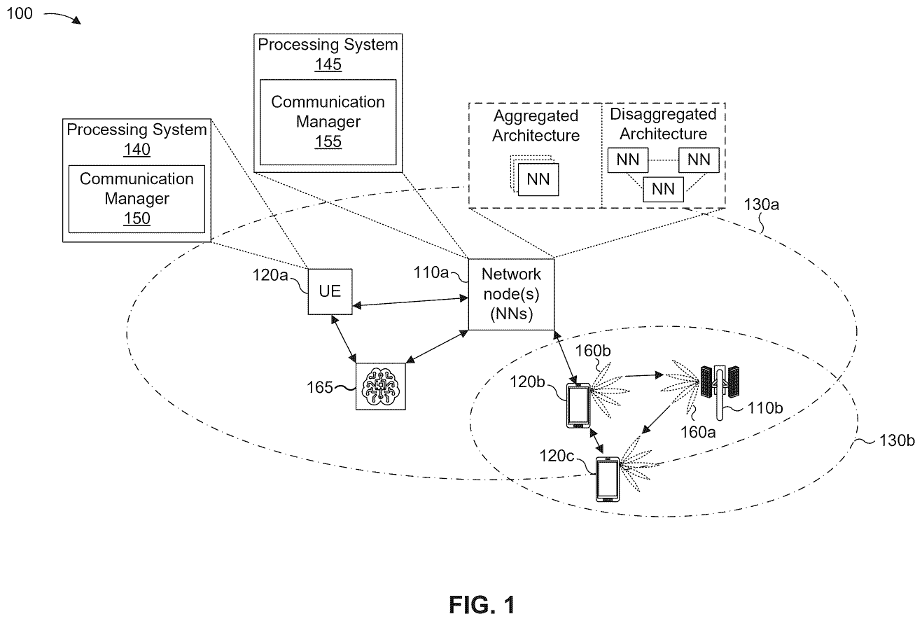

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally, or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

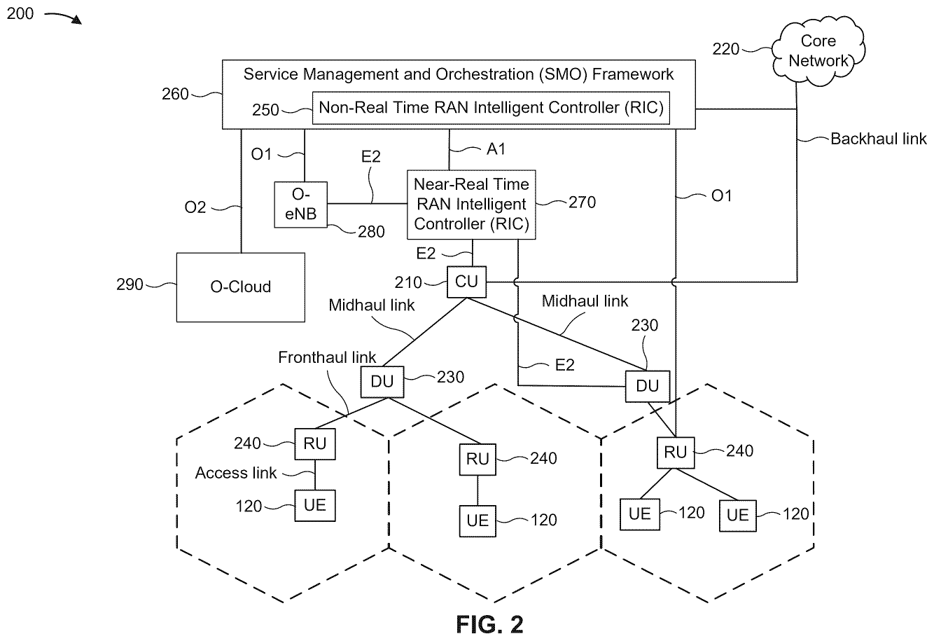

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, HARQ information, NDIs, among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC-CE, an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include PUCCHs, and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ-ACK indication or a HARQ-NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may transmit, to a network node, an L2 HARQ indication; receive, from the network node, a message indicating unsuccessful decoding of the L2 HARQ indication; and retransmit, to the network node, the L2 HARQ indication based on the message indicating the unsuccessful decoding of the L2 HARQ indication. Additionally, or alternatively, the communication manager 150 may perform one or more other operations described herein.

In some aspects, the network node 110 may include a communication manager 155. As described in more detail elsewhere herein, the communication manager 155 may receive, from a UE, an L2 HARQ indication; transmit, to the UE, a message indicating unsuccessful decoding of the L2 HARQ indication; and receive, from the UE, a retransmission of the L2 HARQ indication. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

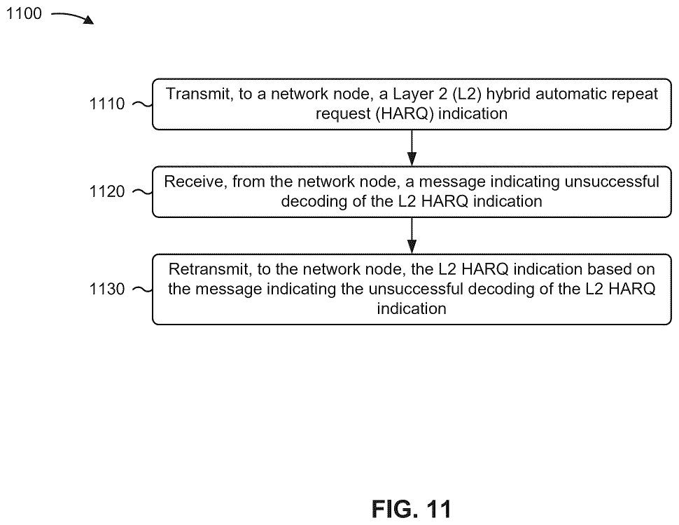

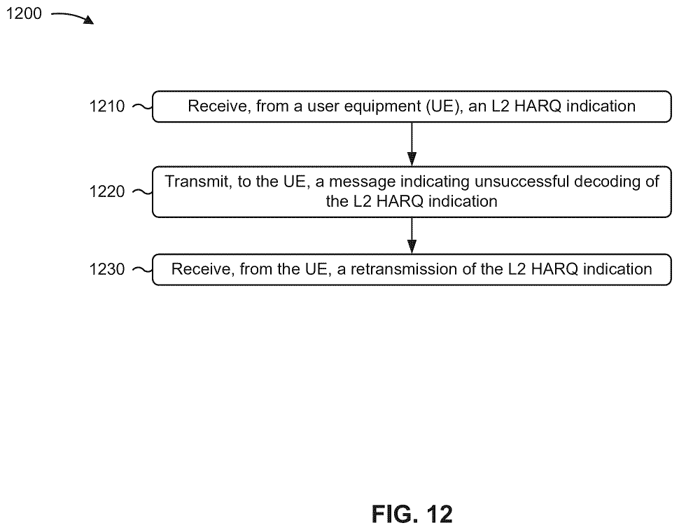

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with retransmission of L2 HARQ indication, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

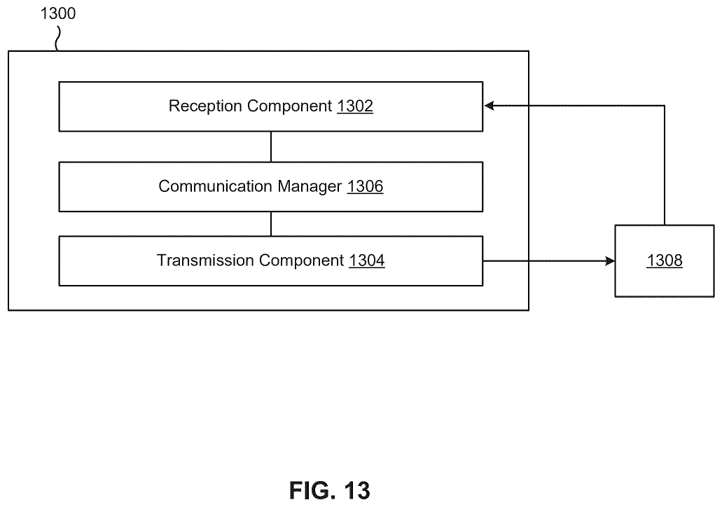

In some aspects, the UE 120 includes means for transmitting, to a network node, an L2 HARQ indication; means for receiving, from the network node, a message indicating unsuccessful decoding of the L2 HARQ indication; and/or means for retransmitting, to the network node, the L2 HARQ indication based on the message indicating the unsuccessful decoding of the L2 HARQ indication. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

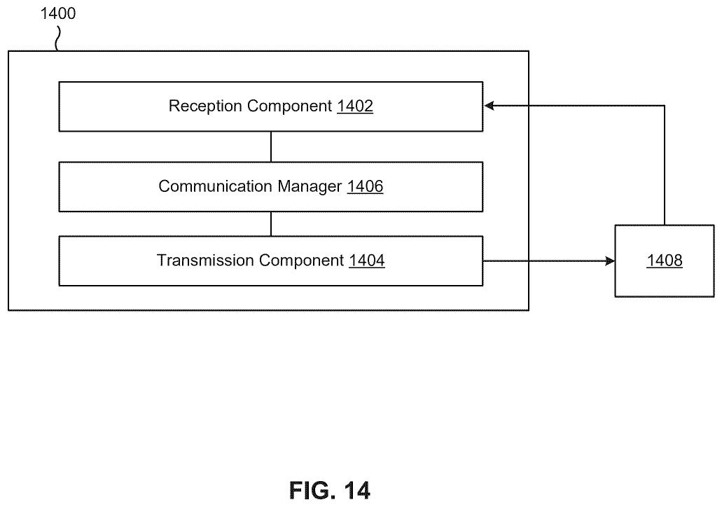

In some aspects, the network node 110 includes means for receiving, from a UE, an L2 HARQ indication; means for transmitting, to the UE, a message indicating unsuccessful decoding of the L2 HARQ indication; and/or means for receiving, from the UE, a retransmission of the L2 HARQ indication. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), and/or a transmission component (for example, transmission component 1404 depicted and described in connection with FIG. 14), among other examples.

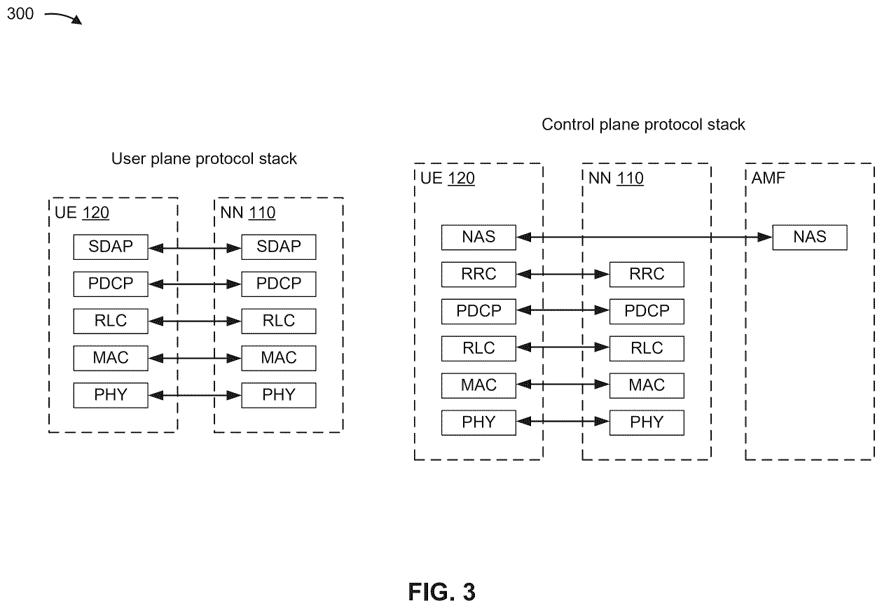

FIG. 3 is a diagram illustrating an example 300 of a user plane protocol stack and a control plane protocol stack for a network node 110 and a core network in communication with a UE 120, in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes 110 (in examples where the protocol stack is distributed across network nodes 110) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective RRC layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 3, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as L2. Thus, in some cases, the SDAP, PDCP, RLC, and MAC layers are referred to as sublayers of L2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the physical layer on transport channels, scheduling information reporting, error correction through HARQ, priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

In some examples, the MAC layer supports a MAC-CE structure, which may be used to carry control information between the UE 120 and the network node 110. The MAC-CE may be implemented as a bit string in the logical channel identification (LCID) field of a MAC sub-header, where the LCID value may indicate the type of control information carried by the MAC-CE. For example, a PUSCH transmission may be used to carry a MAC-CE that includes control information related to buffer status reports, cell radio network temporary identifiers (C-RNTIs), configuration grant confirmations, power headroom reports, or the like.

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 3 is provided as an example. Other examples may differ from what is described with regard to FIG. 3.

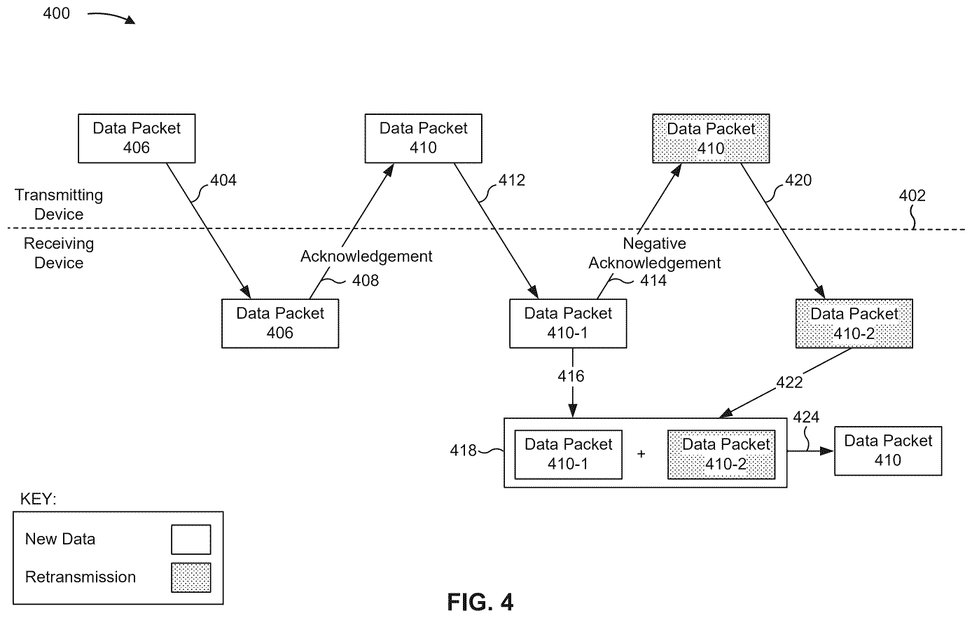

FIG. 4 is a diagram illustrating an example 400 of a HARQ protocol, in accordance with the present disclosure.

A MAC layer of a protocol stack may implement a HARQ protocol to provide a faster retransmission mechanism relative to other retransmission mechanisms, such as an RLC layer retransmission system. In some aspects, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some aspects, and as part of a HARQ process, a network node 110 may transmit information in DCI that indicates to a receiving device (e.g., a UE 120) which downlink transmission(s) and/or which uplink transmissions to process using a HARQ protocol. Alternatively, or additionally, and as part of the HARQ process, a first UE 120 may transmit information in sidelink control information (SCI) that indicates, to a second UE 120, which sidelink transmission(s) to process using the HARQ protocol.

In some aspects, a HARQ process and/or HARQ protocol may enable a receiving device to correct errors in a received data packet, such as by correcting errors within a TB based at least in part on soft combining packets in a PHY layer as described below. In some aspects, a TB may be partitioned into one or more code block groups (CBGs), and each CBG may partitioned into one or more code blocks (CBs). To correct for errors, the receiving device may buffer one or more data packets that have been identified as including an error, combine the data packets, and process the combined data packets to reduce errors. In some aspects, a “codeword (CW)” may refer to a TB that includes error protection, and a transmission may include multiple CWs.

The example 400 includes operations between a transmitting device and a receiving device. Operations and/or data located above dashed line 402 are performed by, and/or reside at, a transmitting device (e.g., a network node 110 for a downlink HARQ process, a UE 120 for an uplink HARQ process, and/or a first UE 120 for a sidelink HARQ process). Operations and/or data located below the dashed line 402 are performed by, and/or reside at, a receiving device (e.g., a UE 120 for a downlink HARQ process, a network node 110 for an uplink HARQ process, and/or a second UE 120 for a sidelink HARQ process). As shown by reference number 404, the transmitting device may transmit a first data packet 406 that is a new transmission of data that is included in the first data packet 406 (e.g., a first transmission of the data, shown through the use of solid white). In some aspects, the transmitting device may buffer and/or store the first data packet 406 as part of a HARQ process until receiving an indication from the receiving device that the first data packet 406 has been received and/or recovered with minimal errors (e.g., error-free and/or a number of errors that satisfy an error threshold). Based at least in part on receiving the first data packet 406 with minimal errors, the receiving device may transmit an ACK to the transmitting device as shown by reference number 408, such as a HARQ acknowledgement. The receiving device may validate the first data packet 406 using any suitable error detection mechanism., such as a cyclic redundancy check (CRC) process that validates the received data by computing a CRC value using the received data and comparing the computed CRC value(s) to a CRC value included with the received data.

Based at least in part receiving the ACK, the transmitting device may transmit a second data packet 410 as shown by reference number 412, and the second data packet 410 may be a new transmission of data (e.g., different data than the data included in the first data packet 406). In a similar manner as the first data packet 406, the transmitting device may store the second data packet 410 in the buffer and/or remove the first data packet 406 from the buffer. In some aspects, the receiving device may not receive the second data packet 410 successfully, shown in FIG. 4 as data packet 410-1. For example, the receiving device may identify that the data packet 410-1 was received with a number of errors that fails to satisfy the error threshold. Accordingly, and as shown by reference number 414, the receiving device may transmit a NACK to indicate that the second data packet 410 was received with errors and/or unsuccessfully. Additionally, or alternatively, the receiving device may transmit the NACK to indicate a request for a retransmission of the second data packet 410. In some aspects, and as shown by reference number 416, the receiving device may store the data packet 410-1 in a buffer 418.

Based at least in part on receiving the NACK, and as shown by reference number 420, the transmitting device may retransmit the second data packet 410 to the receiving device, where the retransmission is shown by FIG. 4 through the use of a dotted pattern. The receiving device may receive the retransmission of the second data packet 410 (shown as data packet 410-2), and, as shown by reference number 422, the receiving device may store the data packet 410-2 in the buffer 418 and/or may combine the data packet 410-1 with the data packet 410-2. As one example, the receiving device may combine the data packet 410-1 and the data packet 410-2 prior to channel decoding and/or error detection, and may process the combined data packet to mitigate errors as shown by reference number 424. That is, by processing the combined data packet, the receiving device may recover data that includes minimal errors (e.g., is error-free and/or includes a number of errors that satisfy the error threshold). In some aspects, the receiving may combine the data packet 410-1 and the data packet 410-2 using soft combining. “Soft combining” may denote combining multiple received signals based at least in part on a confidence and/or reliability of each received signal, such as by combining received signals using a log likelihood ratio (LLR), to improve a signal quality of the combined data packet and reduce recovery errors.

In some examples, an NDI may be used to determine whether a received TB is a new transmission or a retransmission. For example, when the NDI is toggled in DCI including a downlink grant, the toggled NDI may indicate that the downlink grant schedules a new downlink TB. Similarly, when the NDI is toggled in DCI including an uplink grant, the toggled NDI may indicate that the uplink grant is for the UE to transmit a new uplink TB. On the other hand, when scheduling DCI includes an untoggled NDI, the untoggled NDI indicates that the DCI includes a grant for a retransmission of a previous TB associated with a HARQ process indicated in the DCI.

In some aspects, the receiving device may transmit an ACK to the transmitting device, such as in scenarios that the receiving device is able to recover a version of the second data packet 410 that includes minimal errors. In other aspects, the receiving device may transmit a NACK to the transmitting device, such as in scenarios that the receiving device is unable to recover a version of the second data packet 410 with minimal errors.

A HARQ process may be used to improve reliability any combination of PDSCH transmissions, PUSCH transmissions, and/or physical sidelink shared channel (PSSCH) transmissions. Accordingly, the first data packet 406 and/or the second data

packet 410 shown by FIG. 4 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUCCH transmissions, the receiving device (e.g., a UE 120) may transmit ACK/NACK feedback via UCI. For PUSCH transmissions, the receiving device (e.g., a network node 110) may transmit ACK/NACK feedback in an uplink grant (e.g., indicated via DCI). For a sidelink transmission, the receiving device (e.g., a UE 120) may transmit ACK/NACK feedback via a physical sidelink feedback channel (PSFCH).

However, transmitting ACK/NACK feedback via PUCCH may involve a complicated implementation, including numerous procedures to decide payload size, format, and location, as well as transmission size restrictions. In some aspects described herein, by transmitting ACK/NACK feedback via L2, the UE may improve transmission efficiency by adapting transmissions to network conditions and to available resources, and the UE may reduce the complexity of the ACK/NACK feedback protocol.

As indicated above, FIG. 4 is provided as an example. Other examples may differ from what is described with respect to FIG. 4.

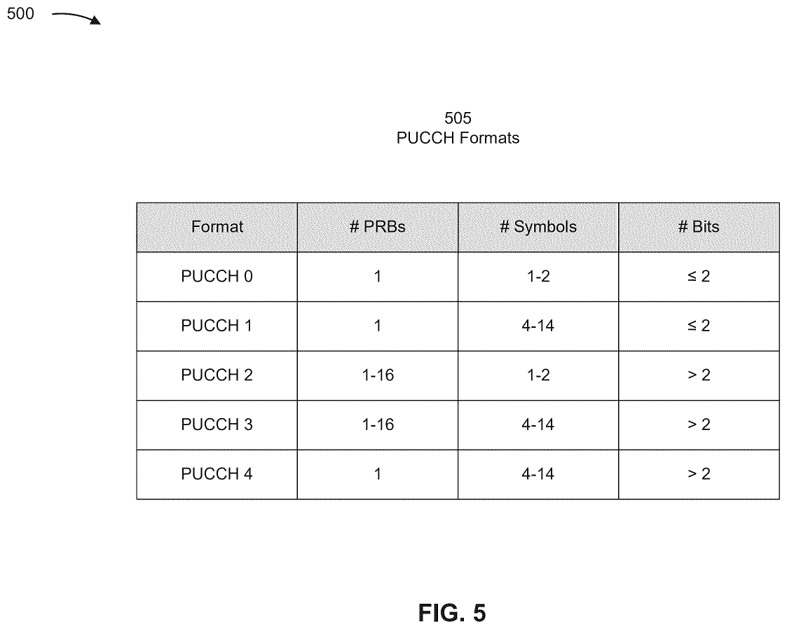

FIG. 5 is a diagram illustrating an example 500 of PUCCH formats, in accordance with the present disclosure.

As shown by reference number 505, in some examples, a PUCCH may be associated with one of five separate formats, designated as PUCCH format 0 through PUCCH format 4 and categorized according to an associated capacity and duration. For example, PUCCH format 0 and PUCCH format 1 can be used to transfer small payloads (e.g., one or two HARQ indications plus a scheduling request), but are unable to transfer CSI reports. In contrast, PUCCH format 2, PUCCH format 3, and PUCCH format 4 are able to accommodate larger payloads, which can include CSI reports. In some examples, formats PUCCH format 0 and PUCCH format 2 may have short durations of one or two symbols, which may be used for low latency applications in which UCI is transferred with minimal delay. In contrast, PUCCH format 1, PUCCH format 3, and PUCCH format 4 have longer durations of at least four symbols and up to fourteen symbols, which may improve coverage and capacity, but increase latency. Accordingly, a PUCCH format may be selected according to numerous factors, including payload size, latency, or the like.

In some examples, the channel coding for UCI may include 1 bit associated with repetition, 2 bits associated with simplex, 2-11 bits associated with Reed-Muller (RM)-based block codes, with no cyclic redundancy check (CRC), and 12 or more bits associated with polar encoding with CRC. Additionally, UCI may be limited to 1723 bits, and there may be procedures for reducing a UCI size when the UCI size exceeds the size limit.

As indicated above, FIG. 5 is provided as an example. Other examples may differ from what is described with respect to FIG. 5.

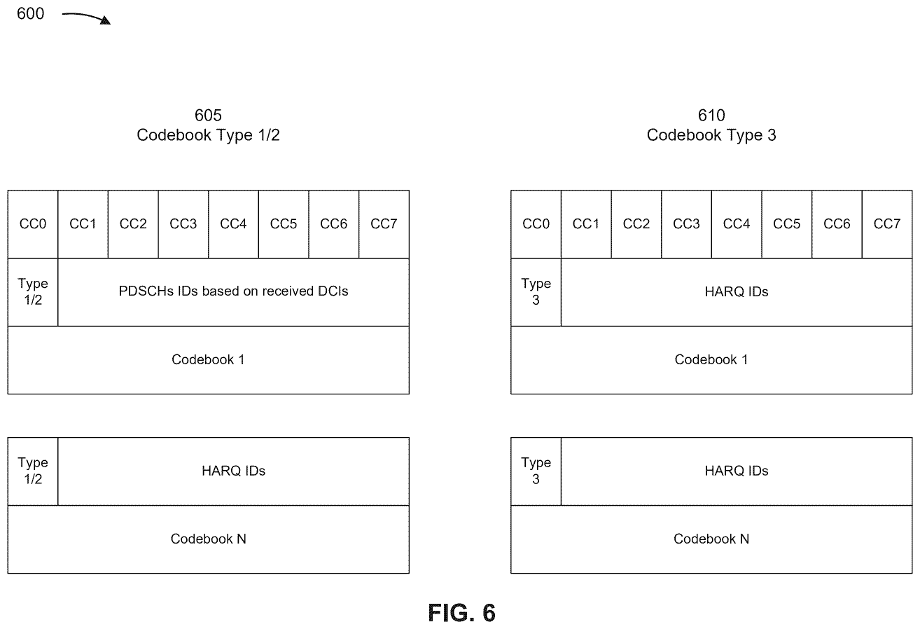

FIG. 6 is a diagram illustrating examples 600 of a HARQ-ACK codebook structure, in accordance with the present disclosure.

In some examples, a HARQ-ACK codebook may indicate a format used to signal a set of HARQ-ACKs (or NACKs) to a network node. A HARQ-ACK codebook may include a sequence of bits constructed using ACK and/or NACK feedback for PDSCH receptions in a time period. For example, a HARQ-ACK codebook may include information associated with one or more component carriers (CCs), a HARQ-ACK codebook type, one or more HARQ IDs, and one or more codebooks. In some examples, the HARQ-ACK codebook may accommodate for multiple CCs in carrier aggregation scenarios, and the HARQ-ACK codebook may include information concerning a selected codebook type. Additionally, the HARQ ID may include information concerning HARQ processes supported per UE, and the codebook may indicate the sequence of bits representing the ACK or NACK feedback for received PDSCHs and/or PDSCH IDs based on received DCIs.

In some examples, a UE may acknowledge multiple CBGs or TBs together, including in carrier aggregation scenarios where multiple TBs may be received per transmission time interval (TTI). Additionally, the UE may determine the quantity of HARQ indicator (e.g., ACK or NACK) bits to transmit and how to transmit the HARQ indicator bits according to a selected codebook, which may have a fixed size or a variable size depending on how many CCs are activated and whether reporting is per CC or over all CCs. As shown by reference number 605, a first codebook type (e.g., Type 1) may be a fixed sized codebook provided by the network node via RRC signaling, but the number of bits in a codebook associated with the first codebook type may be relatively high (e.g., for carrier aggregation with a large number of component carriers) where only a portion of the transmitted bits may be relevant. A second codebook type (e.g., Type 2) may have a dynamic size and may change according to resource allocations, which may reduce inefficiencies caused by unused transmission occasions, but the process of maintaining the correct calculations between actual transmission and feedback may increase the complexity of the HARQ indication feedback.

As shown by reference number 610, a third codebook type (e.g., Type 3) may be used to send an ACK/NACK report for all HARQ processes and all CCs configured in a PUCCH group, which may reduce overhead compared to fixed size (e.g., semi-static) codebooks and may enable a UE to adapt to varying network conditions and requirements, thereby permitting increased reporting flexibility.

As indicated above, FIG. 6 is provided as an example. Other examples may differ from what is described with respect to FIG. 6.

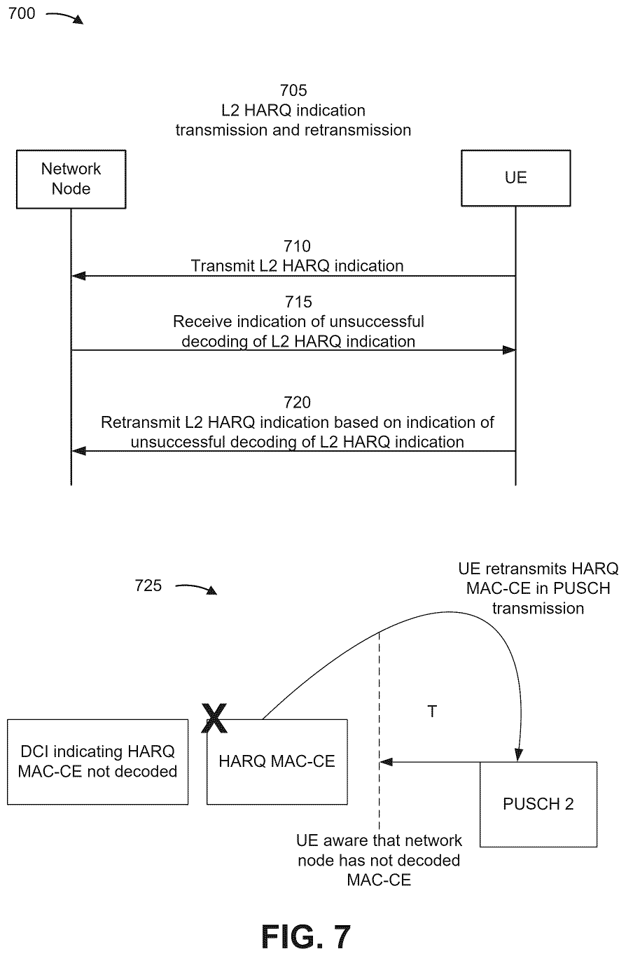

FIG. 7 is a diagram illustrating an example 700 associated with retransmission of an L2 HARQ indication, in accordance with the present disclosure. As shown in FIG. 7, example 700 includes communication between a network node and a UE. In some aspects, the network node and the UE may be included in a wireless network, such as wireless network 100. The network node and the UE may communicate via a wireless access link, which may include an uplink and a downlink.

As shown by reference number 705, an L2 HARQ indication may be transmitted to a network node and retransmitted based on an indication that the L2 HARQ indication was not received or was unsuccessfully decoded at the network node. As shown by reference number 710, the UE may transmit, and the network node may receive, an L2 HARQ indication (e.g., ACK or NACK) indicating whether a downlink transmission associated with a HARQ process was successfully decoded. For example, the initial L2 HARQ indication may be transmitted in a first PUSCH. As shown by reference number 715, where the L2 HARQ indication was not received or was not successfully decoded at the network node, the network node may transmit, and the UE may receive, a message indicating unsuccessful decoding of the L2 HARQ indication. As further shown by reference number 720, the UE may retransmit, and the network node may receive, the L2 HARQ indication based on the message indicating the unsuccessful decoding of the L2 HARQ indication. In some aspects, an L2 HARQ indication may be a HARQ MAC-CE, and a HARQ MAC-CE may be one example of an L2 HARQ indication.

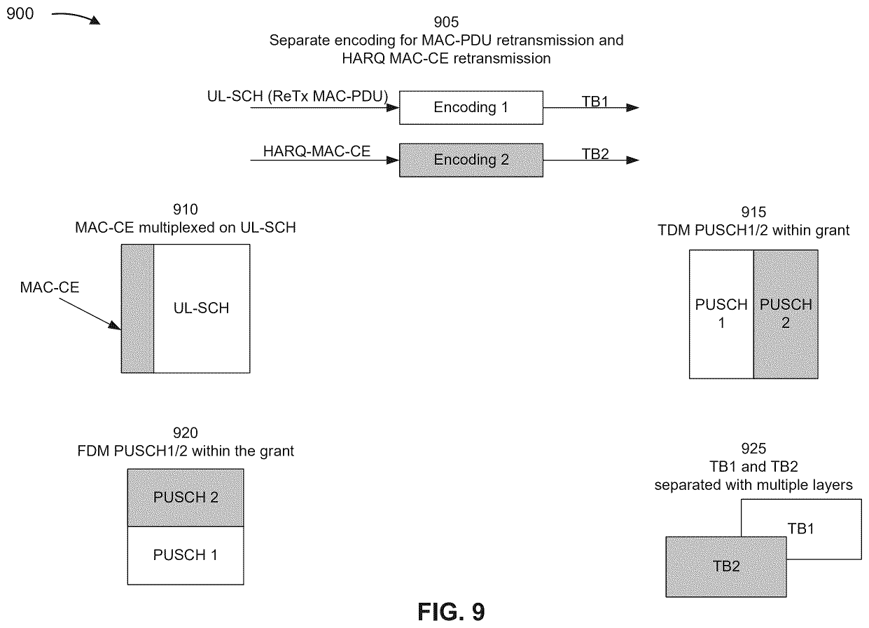

As shown by reference number 725, where the L2 HARQ indication is a MAC-CE that is multiplexed in the MAC-PDU (e.g., a TB) and the HARQ MAC-CE was not correctly decoded at the network node, the UE may retransmit the HARQ MAC-CE using a second PUSCH (e.g. in a dedicated configured grant (CG) or dynamic grant (DG) scheduled after the initial transmission). In some aspects, the UE may retransmit the HARQ MAC-CE in a PUSCH transmission (e.g., the second PUSCH) if the UE receives and/or becomes aware of (e.g., based on DFI for the first PUSCH carrying the L2 HARQ indication or retransmission DCI scheduling a retransmission of the first PUSCH carrying the L2 HARQ indication) an indication of the unsuccessful decoding of an initial HARQ MAC-CE indication at least a threshold time prior to the PUSCH transmission. For example, where the UE receives an indication of the unsuccessful decoding of the initial HARQ MAC-CE indication prior to the PUSCH transmission and a time period between the indication and the PUSCH transmission satisfies (e.g., is greater than or equal to) the threshold, the UE may retransmit the HARQ MAC-CE in the PUSCH transmission. In some aspects, the threshold may be related to the associated timeline for preparing the MAC-CE according to the capabilities of the UE and/or related to a timeline associated with received feedback for unsuccessful decoding of the HARQ MAC-CE. Additionally, the HARQ MAC-CE can be padded to the MAC-SDU in the same MAC-PDU, or the HARQ MAC-CE and the MAC-SDU may share the same grant but may be transmitted in different PUSCHs (e.g., discussed in FIG. 9).

In some aspects, the message indicating the unsuccessful decoding of the initial L2 HARQ indication (e.g., a HARQ MAC-CE carrying ACK/NACK feedback) may include retransmission DCI indicating a HARQ process identifier associated with the L2 HARQ indication with an untoggled NDI. For example, where a retransmission is based on an uplink grant scheduling a retransmission (e.g., an uplink DCI indicating the same HARQ process identifier and untoggled NDI associated with the initial transmission of the L2 HARQ indication), there may be new HARQ-ACK or HARQ NACK codebook constructed in the meantime based on new downlink grants. As a result, a new uplink grant with toggled NDI (e.g., for the initial L2 HARQ indication) or a CG-PUSCH resource may be utilized for the initial transmission of the L2 HARQ indication. Accordingly, the UE may transmit multiple L2 HARQ indications (e.g., HARQ MAC-CEs) on different PUSCHs with different HARQ IDs. For example, each L2 HARQ indication may have a separate triggering condition and may follow MAC layer transmission procedures (e.g., for the initial L2 HARQ indication transmission and the retransmission of the L2 HARQ indication) without combining each L2 HARQ indication in the same uplink TB when the L2 HARQ indications are from different codebooks. In some aspects, the triggering conditions may be based on a k1 offset in the DCI that points to a PUSCH resource, based on an explicit trigger in the DCI, based on an event-based threshold, or based on an aperiodic configuration. For example, the k1 parameter may indicate when the UE may transmit a corresponding L2 HARQ indication for a received PDSCH TB.

As described herein, transmitting a HARQ indicator via a PUCCH results in increased complexity and inefficiencies, including transmission size restrictions and numerous procedures to determine a payload size, PUCCH format, and/or location for the HARQ indicator with the PUCCH payload. By transmitting and retransmitting HARQ indicators via an L2 (e.g., via a HARQ MAC-CE), the transmission (and possible retransmission) for HARQ feedback may be simplified, where, for example, complexity based upon PUCCH format and/or multiplexing rules may be reduced. Additionally, by utilizing a threshold time, the L2 HARQ indication may be adapted to the preparation capabilities of the UE, thereby increasing efficiency in utilizing available uplink transmission resources. For example, where the UE receives an indication that the L2 HARQ indication was not successfully decoded at least a threshold time before an available PUSCH transmission resource (e.g., scheduled via an uplink grant in DCI, or associated with a CG-PUSCH configuration), the UE may be able to successfully include the retransmission of the L2 HARQ indication in an available PUSCH transmission resource, thereby increasing the efficient utilization of available uplink resources.

As indicated above, FIG. 7 is provided as an example. Other examples may differ from what is described with respect to FIG. 7.

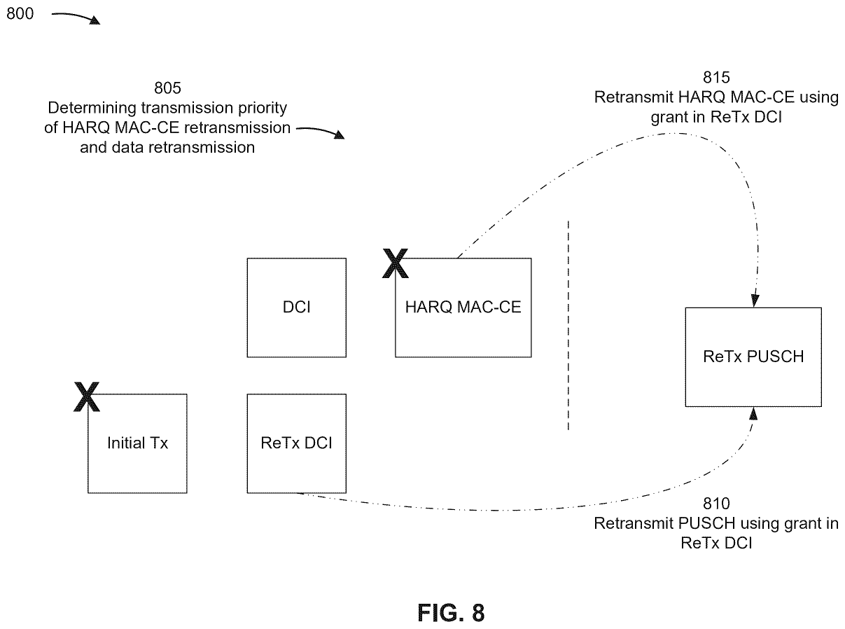

FIG. 8 is a diagram illustrating an example 800 associated with retransmission of an L2 HARQ indication, in accordance with the present disclosure.

As shown by reference number 805, the network node may transmit, and the UE may receive (e.g., via DCI), prioritization and/or rules for a data retransmission and an L2 HARQ indication retransmission associated with using a granted PUSCH resource for an L2 HARQ indication retransmission or a data retransmission (e.g., a retransmission of an L2 SDU). For example, where a PUSCH resource (e.g., the second PUSCH, associated with the L2 HARQ indication retransmission) is a grant scheduled for the retransmission of a previous TB, embedding the L2 HARQ indication retransmission and the L2 SDU retransmission in a single TB (e.g., one MAC-PDU) may interfere with the process of combining data packets at the PHY layer of the retransmission MAC-SDU, thereby rendering multiplexing of the L2 HARQ indication retransmission and the L2 SDU retransmission within the PUSCH resource potentially unviable. Accordingly, in some aspects, a scheduling indicator and/or a priority indicator may be used to determine whether to prioritize the retransmission of the L2 HARQ indicator or the retransmission of the L2 SDU.

In some aspects, the scheduling indicator and/or the priority indicator may be implemented according to one or more configurations. As shown by reference number 810, in a first configuration, the UE may be configured to drop the L2 HARQ indication and prioritize transmission of the L2 SDU. For example, the UE may receive retransmission DCI that grants a first PUSCH resource for a retransmission of the L2 SDU, and the UE may retransmit the L2 SDU in the first PUSCH resource and retransmit the L2 HARQ indicator in a second PUSCH resource. As shown by reference number 815, in a second configuration, the UE may be configured to drop the L2 SDU and prioritize transmission of the L2 HARQ indication. For example, the UE may receive retransmission DCI that grants a first PUSCH resource for retransmission of the L2 SDU, but the UE may retransmit the L2 HARQ indicator in the first PUSCH resource and retransmit the L2 SDU in the second PUSCH resource.

In a third configuration, the UE may be configured to prioritize retransmission of the L2 SDU or the L2 HARQ indication according to a priority indicator. For example, the UE may receive a retransmission DCI that grants a first PUSCH resource for retransmission of the L2 SDU, and the DCI may include a priority indicator associated with the L2 SDU or the L2 HARQ indication. Accordingly, the UE may retransmit the L2 HARQ indication using the first PUSCH resource, and may retransmit the L2 SDU using the second PUSCH resource based on the priority indicator being associated with the L2 HARQ indication. Alternatively, the UE may retransmit the L2 SDU using the first PUSCH resource and the L2 HARQ indication using the second PUSCH resource based on the priority indicator being associated with the L2 SDU.

In a fourth configuration, the UE may be configured to drop either the L2 HARQ indication or the L2 SDU based on a priority associated with the MAC layer, where any conflict between the L2 HARQ indication and the L2 SDU may be resolved at the MAC layer (e.g., the MAC layer of the UE). For example, the MAC layer may resolve the conflict based on transmit power requirements, multiplexing considerations (e.g., whether to puncture PUSCH data to accommodate UCI), or the like.

As described herein, the UE may retransmit the L2 SDU and the L2 HARQ indication according to a scheduling configuration and/or a priority configuration, thereby enabling the UE to adapt retransmissions to network conditions and efficiently utilize available transmission resources. For example, the scheduling indicator and/or the priority indicator may indicate a configuration based on the size of the L2 SDU and/or the L2 HARQ indication, to efficiently utilize available resources in a TB and increase spectral efficiency.

As indicated above, FIG. 8 is provided as an example. Other examples may differ from what is described with respect to FIG. 8.

FIG. 9 is a diagram illustrating examples 900 associated with retransmission of an L2 HARQ indication, in accordance with the present disclosure.

In some aspects, where sufficient uplink resources are available within an uplink grant to transmit an L2 HARQ indication retransmission together with a L2 SDU retransmission (e.g., in separate TBs), separate encoding may be utilized for the L2 HARQ indication retransmission and the L2 SDU retransmission. For example, encoding the L2 HARQ indication and the L2 SDU retransmission separately may enable more efficient and flexible use of uplink resources while permitting both the L2 HARQ indication and the L2 SDU to be transmitted using the same uplink grant.

As shown by reference number 905, where there are sufficient resources within the uplink grant, the HARQ MAC-CE retransmission and the MAC-SDU retransmission may be transmitted together, where the UL-SCH (e.g., including a MAC-SDU retransmission) may be encoded separately from the HARQ MAC-CE retransmission. For example, a UE may receive retransmission DCI that grants a PUSCH resource for retransmission of an L2 SDU, and the UE may retransmit the L2 SDU and the L2 HARQ indication in the PUSCH resource, where the L2 SDU is encoded according to a first encoding configuration and the L2 HARQ indication is encoded according to a second encoding configuration, such that the L2 HARQ indication and the L2 SDU are multiplexed (e.g., in separate TBs) within the PUSCH resource granted by the retransmission DCI.

As shown by reference number 910, where there are sufficient uplink resources within an uplink grant to transmit the HARQ MAC-CE retransmission and the MAC-SDU retransmission together in a single PUSCH, the HARQ MAC-CE symbols and the UL-SCH (or MAC-SDU) data may be mapped to different resource elements (REs) in the PUSCH. In some aspects, the network node may then extract the frequency tones that correspond to the HARQ MAC-CE to enable the network node to decode the HARQ MAC-CE. Similarly, the network node may extract the frequency tones that correspond to the UL-SCH data to enable the network node to decode the UL-SCH data. For example, the L2 HARQ indication and the L2 SDU may be mapped to different sets of REs that are multiplexed in a single PUSCH transmission.

As shown by reference number 915, where there are sufficient uplink resources within an uplink grant to transmit the HARQ MAC-CE retransmission and the MAC-SDU retransmission together, the HARQ MAC-CE retransmission and the MAC-SDU retransmission may be mapped to separate PUSCHs according to a time division multiplexing (TDM) configuration such that the HARQ MAC-CE retransmission and the MAC-SDU retransmission can be considered as separate PUSCHs. For example, the L2 HARQ indication and the L2 SDU may be mapped to separate PUSCH transmissions that are multiplexed to different resources in a time domain (e.g., different symbols) according to the TDM configuration.

As shown by reference number 920, where there are sufficient uplink resources within an uplink grant to transmit the HARQ MAC-CE retransmission and the MAC-SDU retransmission together, the HARQ MAC-CE retransmission and the MAC-SDU retransmission may be mapped to separate PUSCHs according to a frequency division multiplexing (FDM) configuration such that the HARQ MAC-CE retransmission and the MAC-SDU retransmission can be considered as separate PUSCHs. For example, the L2 HARQ indication and the L2 SDU may be mapped to separate PUSCH transmissions that are multiplexed to different resources in a frequency domain (e.g., different resource blocks) according to the FDM configuration.

As shown by reference number 925, where there are sufficient uplink resources within an uplink grant to transmit the HARQ MAC-CE retransmission and the MAC-SDU retransmission together, a first TB (e.g., TB1) and a second TB (e.g., TB2) may be separated in multiple layers, where the MAC-SDU retransmission may be mapped to a first set of layers (e.g., layer 0 and layer 1) of the first TB and the HARQ MAC-CE retransmission may be mapped to a second set of layers (e.g., layer 2 and layer 3) of the second TB. In some aspects, the UL-SCH data (e.g., including the MAC-SDU retransmission) may be mapped to all layers of the first TB, and the HARQ MAC-CE retransmission may be mapped to all layers of the second TB. For example, the L2 HARQ indication and the L2 SDU retransmission may be mapped to different sets of layers that are multiplexed in a single PUSCH transmission. In some aspects, the L2 HARQ indication and the L2 SDU may be mapped to different sets of layers in different TBs that are multiplexed in a single PUSCH transmission.

In some aspects described herein, a HARQ indication may be retransmitted on a HARQ MAC-CE, and where there are sufficient uplink resources within a grant, the HARQ MAC-CE may be transmitted together with a MAC-SDU retransmission. By encoding the L2 HARQ indication and the L2 SDU retransmission separately, the UE may utilize uplink resources more efficiently and flexibly while permitting both the L2 HARQ indication and the L2 SDU to be transmitted within the same grant. For example, separating the L2 SDU (e.g., UL-SCH data) retransmission and the L2 HARQ indication (e.g., UCI) retransmission may enable processing tailored for each type of information and may enable flexible allocation of resources between UL-SCH data and UCI. Additionally, the UE may adapt to network conditions by adjusting resource allocation to balance data throughput and signaling reliability, where, for example, the L2 HARQ indication may require higher reliability and accuracy relative to the data retransmission.

As indicated above, FIG. 9 is provided as an example. Other examples may differ from what is described with respect to FIG. 9.

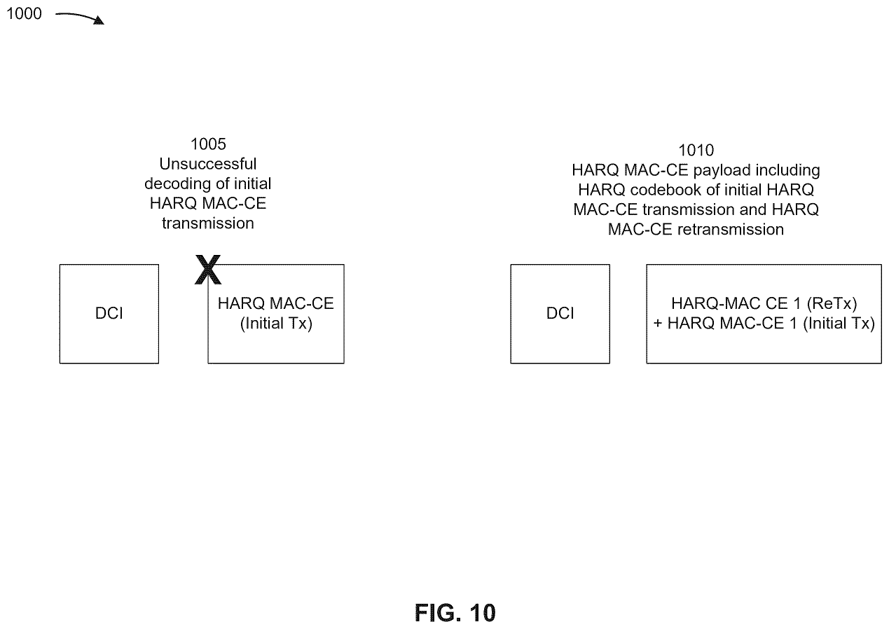

FIG. 10 is a diagram illustrating an example 1000 associated with retransmission of an L2 HARQ indication, in accordance with the present disclosure.

As shown by reference number 1005, a HARQ MAC-CE may not be decoded correctly at a network node, and the network node may indicate, to a UE, the unsuccessful decoding. As shown by reference number 1010, the HARQ MAC-CE retransmission may be combined with the initial HARQ MAC-CE in the next available uplink transmission. In some aspects, the network node may indicate that the UE may generate a new HARQ MAC-CE payload such that the new payload includes both the initial transmission of the HARQ MAC-CE and the retransmission of the HARQ MAC-CE. For example, the large payload size could enable the UE to more efficiently leverage additional channel coding gain.

Additionally, or alternatively, the network may indicate that the UE may retransmit the initial HARQ MAC-CE and the HARQ MAC-CE retransmission in two separate PUSCHs. In some aspects, the LLR for the initial HARQ MAC-CE may be used to combine the initial HARQ MAC-CE with the retransmission of the initial HARQ MAC-CE to combine the gain.

In some aspects, whether the initial HARQ MAC-CE transmission and the HARQ MAC-CE retransmission are combined may be based on the payload size of the HARQ MAC-CE. In some aspects, the network node may indicate a threshold payload size that the UE may utilize to determine whether to generate a new HARQ MAC-CE payload including the initial HARQ MAC-CE transmission and the HARQ MAC-CE retransmission, or to retransmit the initial HARQ MAC-CE transmission and the HARQ MAC-CE retransmission in two separate PUSCHs.

In some aspects described herein, an initial L2 HARQ indication may be combined with a L2 HARQ indication retransmission in a new L2 HARQ indication payload, or the initial L2 HARQ indication and the L2 HARQ indication retransmission may be transmitted in two separate PUSCHs. By combining the initial L2 HARQ indication and the L2 HARQ indication retransmission in a new L2 HARQ payload, the larger payload size may improve channel coding gain, where, for example, the increased code block size may enable use of a higher order modulation scheme to increase spectral efficiency. Additionally, by combining the LLR of the initial L2 HARQ indication with the L2 HARQ indication retransmission, the transmission accuracy may be increased, enabling the use of an increased data rate and/or adapting the data rate to balance throughput and accuracy dependent upon network conditions.

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with retransmission of L2 HARQ indication.

As shown in FIG. 11, in some aspects, process 1100 may include transmitting, to a network node, an L2 HARQ indication (block 1110). For example, the UE (e.g., using transmission component 1304 and/or communication manager 1306, depicted in FIG. 13) may transmit, to a network node, an L2 HARQ indication, as described above.

As further shown in FIG. 11, in some aspects, process 1100 may include receiving, from the network node, a message indicating unsuccessful decoding of the L2 HARQ indication (block 1120). For example, the UE (e.g., using reception component 1302 and/or communication manager 1306, depicted in FIG. 13) may receive, from the network node, a message indicating unsuccessful decoding of the L2 HARQ indication, as described above.

As further shown in FIG. 11, in some aspects, process 1100 may include retransmitting, to the network node, the L2 HARQ indication based on the message indicating the unsuccessful decoding of the L2 HARQ indication (block 1130). For example, the UE (e.g., using transmission component 1304 and/or communication manager 1306, depicted in FIG. 13) may retransmit, to the network node, the L2 HARQ indication based on the message indicating the unsuccessful decoding of the L2 HARQ indication, as described above.

Process 1100 may include additional aspects, such as any single aspect or any combination of aspects described below and/or in connection with one or more other processes described elsewhere herein.

In a first aspect, the L2 HARQ indication is a MAC-CE.

In a second aspect, alone or in combination with the first aspect, retransmitting the L2 HARQ indication includes retransmitting the L2 HARQ indication in a PUSCH transmission based on receiving the message indicating the unsuccessful decoding of the L2 HARQ indication at least a threshold time prior to the PUSCH transmission.

In a third aspect, alone or in combination with one or more of the first and second aspects, the message indicating the unsuccessful decoding of the L2 HARQ indication includes DFI associated with the L2 HARQ indication.

In a fourth aspect, alone or in combination with one or more of the first through third aspects, the message indicating the unsuccessful decoding of the L2 HARQ indication includes retransmission DCI indicating a HARQ process identifier associated with the L2 HARQ indication with an untoggled NDI.

In a fifth aspect, alone or in combination with one or more of the first through fourth aspects, process 1100 includes receiving, from the network node, retransmission DCI that grants a first PUSCH resource for a retransmission of an L2 SDU, and retransmitting the L2 SDU using the first PUSCH resource, wherein the L2 HARQ indication is retransmitted in a second PUSCH resource.

In a sixth aspect, alone or in combination with one or more of the first through fifth aspects, process 1100 includes receiving, from the network node, retransmission DCI that grants a first PUSCH resource for a retransmission of an L2 SDU, and retransmitting the L2 SDU using a second PUSCH resource, wherein the L2 HARQ indication is retransmitted in the first PUSCH resource.

In a seventh aspect, alone or in combination with one or more of the first through sixth aspects, process 1100 includes receiving, from the network node, retransmission DCI that grants a first PUSCH resource for a retransmission of an L2 SDU, wherein the retransmission DCI includes a priority indicator associated with the L2 HARQ indication or the L2 SDU, and retransmitting the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

In an eighth aspect, alone or in combination with one or more of the first through seventh aspects, process 1100 includes receiving, from the network node, a priority indicator associated with the L2 HARQ indication or an L2 SDU, receiving, from the network node, retransmission DCI that grants a first PUSCH resource for a retransmission of the L2 SDU, and retransmitting the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

In a ninth aspect, alone or in combination with one or more of the first through eighth aspects, process 1100 includes receiving, from the network node, retransmission DCI that grants a PUSCH resource for a retransmission of an L2 SDU, and retransmitting, to the network node using the PUSCH resource, the L2 HARQ indication according to a first encoding configuration and the L2 SDU according to a second encoding configuration such that the L2 HARQ indication and the L2 SDU are multiplexed within the PUSCH resource.

In a tenth aspect, alone or in combination with one or more of the first through ninth aspects, the L2 HARQ indication and the L2 SDU are mapped to different sets of REs that are multiplexed in a single PUSCH transmission associated with the PUSCH resource.

In an eleventh aspect, alone or in combination with one or more of the first through tenth aspects, the L2 HARQ indication and the L2 SDU are mapped to separate PUSCH transmissions, associated with the PUSCH resource, that are multiplexed according to TDM.

In a twelfth aspect, alone or in combination with one or more of the first through eleventh aspects, the L2 HARQ indication and the L2 SDU are mapped to separate PUSCH transmissions, associated with the PUSCH resource, that are multiplexed according to FDM.

In a thirteenth aspect, alone or in combination with one or more of the first through twelfth aspects, the L2 HARQ indication and the L2 SDU are mapped to different sets of layers that are multiplexed in a single PUSCH transmission associated with the PUSCH resource.

In a fourteenth aspect, alone or in combination with one or more of the first through thirteenth aspects, the L2 HARQ indication is retransmitted in a payload that combines a first codebook associated with an initial transmission of the L2 HARQ indication with a second codebook associated with a retransmission of the L2 HARQ indication.

In a fifteenth aspect, alone or in combination with one or more of the first through fourteenth aspects, retransmitting the L2 HARQ indication includes transmitting, to the network node, a first PUSCH message that includes a first codebook associated with an initial transmission of the L2 HARQ indication, and transmitting, to the network node, a second PUSCH message that includes a second codebook associated with a retransmission of the L2 HARQ indication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with retransmission of L2 HARQ indication.

As shown in FIG. 12, in some aspects, process 1200 may include receiving, from a UE, an L2 HARQ indication (block 1210). For example, the network node (e.g., using reception component 1402 and/or communication manager 1406, depicted in FIG. 14) may receive, from a UE, an L2 HARQ indication, as described above.

As further shown in FIG. 12, in some aspects, process 1200 may include transmitting, to the UE, a message indicating unsuccessful decoding of the L2 HARQ indication (block 1220). For example, the network node (e.g., using transmission component 1404 and/or communication manager 1406, depicted in FIG. 14) may transmit, to the UE, a message indicating unsuccessful decoding of the L2 HARQ indication, as described above.

As further shown in FIG. 12, in some aspects, process 1200 may include receiving, from the UE, a retransmission of the L2 HARQ indication (block 1230). For example, the network node (e.g., using reception component 1402 and/or communication manager 1406, depicted in FIG. 14) may receive, from the UE, a retransmission of the L2 HARQ indication, as described above.

Process 1200 may include additional aspects, such as any single aspect or any combination of aspects described below and/or in connection with one or more other processes described elsewhere herein.

In a first aspect, the L2 HARQ indication is a MAC-CE.

In a second aspect, alone or in combination with the first aspect, the message indicating the unsuccessful decoding of the L2 HARQ indication includes DFI associated with the L2 HARQ indication.

In a third aspect, alone or in combination with one or more of the first and second aspects, the message indicating the unsuccessful decoding of the L2 HARQ indication includes retransmission DCI indicating a HARQ process identifier associated with the L2 HARQ indication with an untoggled NDI.

In a fourth aspect, alone or in combination with one or more of the first through third aspects, process 1200 includes transmitting, to the UE, retransmission DCI that grants a first PUSCH resource for a retransmission of an L2 SDU, and receiving, from the UE, the L2 SDU in the first PUSCH resource, wherein the retransmission of the L2 HARQ indication is received in a second PUSCH resource.

In a fifth aspect, alone or in combination with one or more of the first through fourth aspects, process 1200 includes transmitting, to the UE, retransmission DCI that grants a first PUSCH resource for a retransmission of an L2 SDU, and receiving, from the UE, the L2 SDU in a second PUSCH resource, wherein the retransmission of the L2 HARQ indication is received in the first PUSCH resource.

In a sixth aspect, alone or in combination with one or more of the first through fifth aspects, process 1200 includes transmitting, to the UE, retransmission DCI that grants a first PUSCH resource for a retransmission of an L2 SDU, wherein the DCI includes a priority indicator associated with the L2 HARQ indication or with the L2 SDU.

In a seventh aspect, alone or in combination with one or more of the first through sixth aspects, process 1200 includes transmitting, to the UE, retransmission DCI that grants a PUSCH resource for a retransmission of an L2 SDU, and receiving, from the UE in the PUSCH resource, the retransmission of the L2 HARQ indication and the retransmission of the L2 SDU, wherein the retransmission of the L2 HARQ indication is associated with a first encoding configuration and the retransmission of the L2 SDU is associated with a second encoding configuration such that the retransmission of the L2 HARQ indication and the retransmission of the L2 SDU are multiplexed within the PUSCH resource.

In an eighth aspect, alone or in combination with one or more of the first through seventh aspects, the retransmission of the L2 HARQ indication and the retransmission of the L2 SDU are mapped to different sets of REs that are multiplexed in a single PUSCH transmission associated with the PUSCH resource.

In a ninth aspect, alone or in combination with one or more of the first through eighth aspects, the retransmission of the L2 HARQ indication and the retransmission of the L2 SDU are mapped to separate PUSCH transmissions, associated with the PUSCH resource, that are multiplexed according to TDM.

In a tenth aspect, alone or in combination with one or more of the first through ninth aspects, the retransmission of the L2 HARQ indication and the retransmission of the L2 SDU are mapped to separate PUSCH transmissions, associated with the PUSCH resource, that are multiplexed according to FDM.

In an eleventh aspect, alone or in combination with one or more of the first through tenth aspects, the retransmission of the L2 HARQ indication and the retransmission of the L2 SDU are mapped to different sets of layers that are multiplexed in a single PUSCH transmission associated with the PUSCH resource.

In a twelfth aspect, alone or in combination with one or more of the first through eleventh aspects, the retransmission of the L2 HARQ indication is received in a payload that combines a first codebook associated with an initial transmission of the L2 HARQ indication with a second codebook associated with the retransmission of the L2 HARQ indication.

In a thirteenth aspect, alone or in combination with one or more of the first through twelfth aspects, receiving the retransmission of the L2 HARQ indication includes receiving, from the UE, a first PUSCH message that includes a first codebook associated with an initial transmission of the L2 HARQ indication, and receiving, from the UE, a second PUSCH message that includes a second codebook associated with the retransmission of the L2 HARQ indication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit, to a network node, an L2 HARQ indication. The reception component 1302 may receive, from the network node, a message indicating unsuccessful decoding of the L2 HARQ indication. The transmission component 1304 may retransmit, to the network node, the L2 HARQ indication based on the message indicating the unsuccessful decoding of the L2 HARQ indication.

The reception component 1302 may receive, from the network node, retransmission DCI that grants a first PUSCH resource for a retransmission of an L2 SDU. The transmission component 1304 may retransmit the L2 SDU using the first PUSCH resource, wherein the L2 HARQ indication is retransmitted in a second PUSCH resource.

The reception component 1302 may receive, from the network node, retransmission DCI that grants a first PUSCH resource for a retransmission of an L2 SDU. The transmission component 1304 may retransmit the L2 SDU using a second PUSCH resource, wherein the L2 HARQ indication is retransmitted in the first PUSCH resource.

The reception component 1302 may receive, from the network node, retransmission DCI that grants a first PUSCH resource for a retransmission of an L2 SDU, wherein the retransmission DCI includes a priority indicator associated with the L2 HARQ indication or the L2 SDU.

The transmission component 1304 may retransmit the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

The reception component 1302 may receive, from the network node, a priority indicator associated with the L2 HARQ indication or an L2 SDU.

The reception component 1302 may receive, from the network node, retransmission DCI that grants a first PUSCH resource for a retransmission of the L2 SDU.

The transmission component 1304 may retransmit the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

The reception component 1302 may receive, from the network node, retransmission DCI that grants a PUSCH resource for a retransmission of an L2 SDU.

The transmission component 1304 may retransmit, to the network node using the PUSCH resource, the L2 HARQ indication according to a first encoding configuration and the L2 SDU according to a second encoding configuration such that the L2 HARQ indication and the L2 SDU are multiplexed within the PUSCH resource.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a UE, an L2 HARQ indication. The transmission component 1404 may transmit, to the UE, a message indicating unsuccessful decoding of the L2 HARQ indication. The reception component 1402 may receive, from the UE, a retransmission of the L2 HARQ indication.

The transmission component 1404 may transmit, to the UE, retransmission DCI that grants a first PUSCH resource for a retransmission of an L2 SDU.

The reception component 1402 may receive, from the UE, the L2 SDU in the first PUSCH resource, wherein the retransmission of the L2 HARQ indication is received in a second PUSCH resource.

The transmission component 1404 may transmit, to the UE, retransmission DCI that grants a first PUSCH resource for a retransmission of an L2 SDU.

The reception component 1402 may receive, from the UE, the L2 SDU in a second PUSCH resource, wherein the retransmission of the L2 HARQ indication is received in the first PUSCH resource.

The transmission component 1404 may transmit, to the UE, retransmission DCI that grants a first PUSCH resource for a retransmission of an L2 SDU, wherein the DCI includes a priority indicator associated with the L2 HARQ indication or with the L2 SDU.

The transmission component 1404 may transmit, to the UE, retransmission DCI that grants a PUSCH resource for a retransmission of an L2 SDU.

The reception component 1402 may receive, from the UE in the PUSCH resource, the retransmission of the L2 HARQ indication and the retransmission of the L2 SDU, wherein the retransmission of the L2 HARQ indication is associated with a first encoding configuration and the retransmission of the L2 SDU is associated with a second encoding configuration such that the retransmission of the L2 HARQ indication and the retransmission of the L2 SDU are multiplexed within the PUSCH resource.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a UE, comprising: transmitting, to a network node, a Layer 2 (L2) hybrid automatic repeat request (HARQ) indication; receiving, from the network node, a message indicating unsuccessful decoding of the L2 HARQ indication; and retransmitting, to the network node, the L2 HARQ indication based on the message indicating the unsuccessful decoding of the L2 HARQ indication.
Aspect 2: The method of Aspect 1, wherein the L2 HARQ indication is a medium access control (MAC) control element (MAC-CE).
Aspect 3: The method of any of Aspects 1-2, wherein retransmitting the L2 HARQ indication includes retransmitting the L2 HARQ indication in a physical uplink shared channel (PUSCH) transmission based on receiving the message indicating the unsuccessful decoding of the L2 HARQ indication at least a threshold time prior to the PUSCH transmission.
Aspect 4: The method of any of Aspects 1-3, wherein the message indicating the unsuccessful decoding of the L2 HARQ indication includes downlink feedback information (DFI) associated with the L2 HARQ indication.
Aspect 5: The method of any of Aspects 1-4, wherein the message indicating the unsuccessful decoding of the L2 HARQ indication includes retransmission downlink control information (DCI) indicating a HARQ process identifier associated with the L2 HARQ indication with an untoggled new data indicator (NDI).
Aspect 6: The method of any of Aspects 1-5, further comprising: receiving, from the network node, retransmission downlink control information (DCI) that grants a first physical uplink shared channel (PUSCH) resource for a retransmission of an L2
service data unit (SDU); and retransmitting the L2 SDU using the first PUSCH resource, wherein the L2 HARQ indication is retransmitted in a second PUSCH resource.
Aspect 7: The method of any of Aspects 1-6, further comprising: receiving, from the network node, retransmission downlink control information (DCI) that grants a first physical uplink shared channel (PUSCH) resource for a retransmission of an L2 service data unit (SDU); and retransmitting the L2 SDU using a second PUSCH resource, wherein the L2 HARQ indication is retransmitted in the first PUSCH resource.
Aspect 8: The method of any of Aspects 1-7, further comprising: receiving, from the network node, retransmission downlink control information (DCI) that grants a first physical uplink shared channel (PUSCH) resource for a retransmission of an L2 service data unit (SDU), wherein the retransmission DCI includes a priority indicator associated with the L2 HARQ indication or the L2 SDU; and retransmitting the L2 SDU, wherein: the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.
Aspect 9: The method of any of Aspects 1-8, further comprising: receiving, from the network node, a priority indicator associated with the L2 HARQ indication or an L2 service data unit (SDU); receiving, from the network node, retransmission downlink control information (DCI) that grants a first physical uplink shared channel (PUSCH) resource for a retransmission of the L2 SDU; and retransmitting the L2 SDU, wherein: the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.
Aspect 10: The method of any of Aspects 1-9, further comprising: receiving, from the network node, retransmission downlink control information (DCI) that grants a physical uplink shared channel (PUSCH) resource for a retransmission of an L2 service data unit (SDU); and retransmitting, to the network node using the PUSCH resource, the
L2 HARQ indication according to a first encoding configuration and the L2 SDU according to a second encoding configuration such that the L2 HARQ indication and the L2 SDU are multiplexed within the PUSCH resource.
Aspect 11: The method of Aspect 10, wherein the L2 HARQ indication and the L2 SDU are mapped to different sets of resource elements (REs) that are multiplexed in a single PUSCH transmission associated with the PUSCH resource.
Aspect 12: The method of Aspect 10, wherein the L2 HARQ indication and the L2 SDU are mapped to separate PUSCH transmissions, associated with the PUSCH resource, that are multiplexed according to time division multiplexing (TDM).
Aspect 13: The method of Aspect 10, wherein the L2 HARQ indication and the L2 SDU are mapped to separate PUSCH transmissions, associated with the PUSCH resource, that are multiplexed according to frequency division multiplexing (FDM).
Aspect 14: The method of Aspect 10, wherein the L2 HARQ indication and the L2 SDU are mapped to different sets of layers that are multiplexed in a single PUSCH transmission associated with the PUSCH resource.
Aspect 15: The method of any of Aspects 1-14, wherein the L2 HARQ indication is retransmitted in a payload that combines a first codebook associated with an initial transmission of the L2 HARQ indication with a second codebook associated with a retransmission of the L2 HARQ indication.
Aspect 16: The method of any of Aspects 1-15, wherein retransmitting the L2 HARQ indication includes: transmitting, to the network node, a first physical uplink shared channel (PUSCH) message that includes a first codebook associated with an initial transmission of the L2 HARQ indication; and transmitting, to the network node, a second PUSCH message that includes a second codebook associated with a retransmission of the L2 HARQ indication.
Aspect 17: A method of wireless communication performed by a network node, comprising: receiving, from a UE, a Layer 2 (L2) hybrid automatic repeat request (HARQ) indication; transmitting, to the UE, a message indicating unsuccessful decoding of the L2 HARQ indication; and receiving, from the UE, a retransmission of the L2 HARQ indication.
Aspect 18: The method of Aspect 17, wherein the L2 HARQ indication is a medium access control (MAC) control element (MAC-CE).
Aspect 19: The method of any of Aspects 17-18, wherein the message indicating the unsuccessful decoding of the L2 HARQ indication includes downlink feedback information (DFI) associated with the L2 HARQ indication.
Aspect 20: The method of any of Aspects 17-19, wherein the message indicating the unsuccessful decoding of the L2 HARQ indication includes retransmission downlink control information (DCI) indicating a HARQ process identifier associated with the L2 HARQ indication with an untoggled new data indicator (NDI).
Aspect 21: The method of any of Aspects 17-20, further comprising: transmitting, to the UE, retransmission downlink control information (DCI) that grants a first physical uplink shared channel (PUSCH) resource for a retransmission of an L2 service data unit (SDU); and receiving, from the UE, the L2 SDU in the first PUSCH resource, wherein the retransmission of the L2 HARQ indication is received in a second PUSCH resource.
Aspect 22: The method of any of Aspects 17-21, further comprising: transmitting, to the UE, retransmission downlink control information (DCI) that grants a first physical uplink shared channel (PUSCH) resource for a retransmission of an L2 service data unit (SDU); and receiving, from the UE, the L2 SDU in a second PUSCH resource, wherein the retransmission of the L2 HARQ indication is received in the first PUSCH resource.
Aspect 23: The method of any of Aspects 17-22, further comprising: transmitting, to the UE, retransmission downlink control information (DCI) that grants a first physical uplink shared channel (PUSCH) resource for a retransmission of an L2 service data unit (SDU), wherein the DCI includes a priority indicator associated with the L2 HARQ indication or with the L2 SDU.
Aspect 24: The method of any of Aspects 17-23, further comprising: transmitting, to the UE, retransmission downlink control information (DCI) that grants a physical uplink shared channel (PUSCH) resource for a retransmission of an L2 service data unit (SDU); and receiving, from the UE in the PUSCH resource, the retransmission of the L2 HARQ indication and the retransmission of the L2 SDU, wherein the retransmission of the L2 HARQ indication is associated with a first encoding configuration and the retransmission of the L2 SDU is associated with a second encoding configuration such that the retransmission of the L2 HARQ indication and the retransmission of the L2 SDU are multiplexed within the PUSCH resource.
Aspect 25: The method of Aspect 24, wherein the retransmission of the L2 HARQ indication and the retransmission of the L2 SDU are mapped to different sets of resource elements (REs) that are multiplexed in a single PUSCH transmission associated with the PUSCH resource.
Aspect 26: The method of Aspect 24, wherein the retransmission of the L2 HARQ indication and the retransmission of the L2 SDU are mapped to separate PUSCH transmissions, associated with the PUSCH resource, that are multiplexed according to time division multiplexing (TDM).
Aspect 27: The method of Aspect 24, wherein the retransmission of the L2 HARQ indication and the retransmission of the L2 SDU are mapped to separate PUSCH transmissions, associated with the PUSCH resource, that are multiplexed according to frequency division multiplexing (FDM).
Aspect 28: The method of Aspect 24, wherein the retransmission of the L2 HARQ indication and the retransmission of the L2 SDU are mapped to different sets of layers that are multiplexed in a single PUSCH transmission associated with the PUSCH resource.
Aspect 29: The method of any of Aspects 17-28, wherein the retransmission of the L2 HARQ indication is received in a payload that combines a first codebook associated with an initial transmission of the L2 HARQ indication with a second codebook associated with the retransmission of the L2 HARQ indication.
Aspect 30: The method of any of Aspects 17-29, wherein receiving the retransmission of the L2 HARQ indication includes: receiving, from the UE, a first physical uplink shared channel (PUSCH) message that includes a first codebook associated with an initial transmission of the L2 HARQ indication; and receiving, from the UE, a second PUSCH message that includes a second codebook associated with the retransmission of the L2 HARQ indication.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, a Layer 2 (L2) hybrid automatic repeat request (HARQ) indication;
receive, from the network node, a message indicating unsuccessful decoding of the L2 HARQ indication; and
retransmit, to the network node, the L2 HARQ indication based on the message indicating the unsuccessful decoding of the L2 HARQ indication.

2. The UE of claim 1, wherein the L2 HARQ indication is a medium access control (MAC) control element (MAC-CE).

3. The UE of claim 1, wherein the one or more processors, to cause the UE to retransmit the L2 HARQ indication, are configured to cause the UE to retransmit the L2 HARQ indication in a physical uplink shared channel (PUSCH) transmission based on receiving the message indicating the unsuccessful decoding of the L2 HARQ indication at least a threshold time prior to the PUSCH transmission.

4. The UE of claim 1, wherein the message indicating the unsuccessful decoding of the L2 HARQ indication includes downlink feedback information (DFI) associated with the L2 HARQ indication.

5. The UE of claim 1, wherein the message indicating the unsuccessful decoding of the L2 HARQ indication includes retransmission downlink control information (DCI) indicating a HARQ process identifier associated with the L2 HARQ indication with an untoggled new data indicator (NDI).

6. The UE of claim 1, wherein the one or more processors are further configured to cause the UE to:
receive, from the network node, retransmission downlink control information (DCI) that grants a first physical uplink shared channel (PUSCH) resource for a retransmission of an L2 service data unit (SDU); and
retransmit the L2 SDU using the first PUSCH resource, wherein the L2 HARQ indication is retransmitted in a second PUSCH resource.

7. The UE of claim 1, wherein the one or more processors are further configured to cause the UE to:
receive, from the network node, retransmission downlink control information (DCI) that grants a first physical uplink shared channel (PUSCH) resource for a retransmission of an L2 service data unit (SDU); and
retransmit the L2 SDU using a second PUSCH resource, wherein the L2 HARQ indication is retransmitted in the first PUSCH resource.

8. The UE of claim 1, wherein the one or more processors are further configured to cause the UE to:
receive, from the network node, retransmission downlink control information (DCI) that grants a first physical uplink shared channel (PUSCH) resource for a retransmission of an L2 service data unit (SDU), wherein the retransmission DCI includes a priority indicator associated with the L2 HARQ indication or the L2 SDU; and
retransmit the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

9. The UE of claim 1, wherein the one or more processors are further configured to cause the UE to:
receive, from the network node, a priority indicator associated with the L2 HARQ indication or an L2 service data unit (SDU);
receive, from the network node, retransmission downlink control information (DCI) that grants a first physical uplink shared channel (PUSCH) resource for a retransmission of the L2 SDU; and
retransmit the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

10. A network node for wireless communication, comprising:
one or more memories; and
one or more processors, coupled to the one or more memories, configured to cause the network node to:
receive, from a user equipment (UE), a Layer 2 (L2) hybrid automatic repeat request (HARQ) indication;
transmit, to the UE, a message indicating unsuccessful decoding of the L2 HARQ indication; and
receive, from the UE, a retransmission of the L2 HARQ indication.

11. The network node of claim 10, wherein the L2 HARQ indication is a medium access control (MAC) control element (MAC-CE).

12. The network node of claim 10, wherein the one or more processors are further configured to cause the network node to:
transmit, to the UE, retransmission downlink control information (DCI) that grants a first physical uplink shared channel (PUSCH) resource for a retransmission of an L2 service data unit (SDU); and
receive, from the UE, the L2 SDU in the first PUSCH resource, wherein the retransmission of the L2 HARQ indication is received in a second PUSCH resource.

13. The network node of claim 10, wherein the one or more processors are further configured to cause the network node to:
transmit, to the UE, retransmission downlink control information (DCI) that grants a first physical uplink shared channel (PUSCH) resource for a retransmission of an L2 service data unit (SDU); and
receive, from the UE, the L2 SDU in a second PUSCH resource, wherein the retransmission of the L2 HARQ indication is received in the first PUSCH resource.

14. The network node of claim 10, wherein the one or more processors are further configured to cause the network node to:
transmit, to the UE, retransmission downlink control information (DCI) that grants a physical uplink shared channel (PUSCH) resource for a retransmission of an L2 service data unit (SDU); and
receive, from the UE in the PUSCH resource, the retransmission of the L2 HARQ indication and the retransmission of the L2 SDU, wherein the retransmission of the L2 HARQ indication is associated with a first encoding configuration and the retransmission of the L2 SDU is associated with a second encoding configuration such that the retransmission of the L2 HARQ indication and the retransmission of the L2 SDU are multiplexed within the PUSCH resource.

15. The network node of claim 14, wherein the retransmission of the L2 HARQ indication and the retransmission of the L2 SDU are mapped to different sets of resource elements (REs) that are multiplexed in a single PUSCH transmission associated with the PUSCH resource.

16. The network node of claim 14, wherein the retransmission of the L2 HARQ indication and the retransmission of the L2 SDU are mapped to separate PUSCH transmissions, associated with the PUSCH resource, that are multiplexed according to time division multiplexing (TDM).

17. The network node of claim 14, wherein the retransmission of the L2 HARQ indication and the retransmission of the L2 SDU are mapped to separate PUSCH transmissions, associated with the PUSCH resource, that are multiplexed according to frequency division multiplexing (FDM).

18. The network node of claim 14, wherein the retransmission of the L2 HARQ indication and the retransmission of the L2 SDU are mapped to different sets of layers that are multiplexed in a single PUSCH transmission associated with the PUSCH resource.

19. The network node of claim 10, wherein the retransmission of the L2 HARQ indication is received in a payload that combines a first codebook associated with an initial transmission of the L2 HARQ indication with a second codebook associated with the retransmission of the L2 HARQ indication.

20. A method of wireless communication performed by a user equipment (UE), comprising:
transmitting, to a network node, a Layer 2 (L2) hybrid automatic repeat request (HARQ) indication;
receiving, from the network node, a message indicating unsuccessful decoding of the L2 HARQ indication; and
retransmitting, to the network node, the L2 HARQ indication based on the message indicating the unsuccessful decoding of the L2 HARQ indication.

21. The method of claim 20, wherein the L2 HARQ indication is a medium access control (MAC) control element (MAC-CE).

22. The method of claim 20, wherein retransmitting the L2 HARQ indication includes retransmitting the L2 HARQ indication in a physical uplink shared channel (PUSCH) transmission based on receiving the message indicating the unsuccessful decoding of the L2 HARQ indication at least a threshold time prior to the PUSCH transmission.

23. The method of claim 20, further comprising:
receiving, from the network node, retransmission downlink control information (DCI) that grants a first physical uplink shared channel (PUSCH) resource for a retransmission of an L2 service data unit (SDU); and
retransmitting the L2 SDU using the first PUSCH resource, wherein the L2 HARQ indication is retransmitted in a second PUSCH resource.

24. The method of claim 20, further comprising:
receiving, from the network node, retransmission downlink control information (DCI) that grants a first physical uplink shared channel (PUSCH) resource for a retransmission of an L2 service data unit (SDU); and
retransmitting the L2 SDU using a second PUSCH resource, wherein the L2 HARQ indication is retransmitted in the first PUSCH resource.

25. The method of claim 20, further comprising:
receiving, from the network node, retransmission downlink control information (DCI) that grants a first physical uplink shared channel (PUSCH) resource for a retransmission of an L2 service data unit (SDU), wherein the retransmission DCI includes a priority indicator associated with the L2 HARQ indication or the L2 SDU; and
retransmitting the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

26. The method of claim 20, further comprising:
receiving, from the network node, a priority indicator associated with the L2 HARQ indication or an L2 service data unit (SDU);
receiving, from the network node, retransmission downlink control information (DCI) that grants a first physical uplink shared channel (PUSCH) resource for a retransmission of the L2 SDU; and
retransmitting the L2 SDU, wherein the L2 HARQ indication is retransmitted using the first PUSCH resource and the L2 SDU is retransmitted using a second PUSCH resource based on the priority indicator being associated with the L2 HARQ indication, or the L2 SDU is retransmitted using the first PUSCH resource and the L2 HARQ indication is retransmitted using the second PUSCH resource based on the priority indicator being associated with the L2 SDU.

27. A method of wireless communication performed by a network node, comprising:
receiving, from a user equipment (UE), a Layer 2 (L2) hybrid automatic repeat request (HARQ) indication;
transmitting, to the UE, a message indicating unsuccessful decoding of the L2 HARQ indication; and
receiving, from the UE, a retransmission of the L2 HARQ indication.

28. The method of claim 27, wherein the L2 HARQ indication is a medium access control (MAC) control element (MAC-CE).

29. The method of claim 27, further comprising:
transmitting, to the UE, retransmission downlink control information (DCI) that grants a first physical uplink shared channel (PUSCH) resource for a retransmission of an L2 service data unit (SDU); and
receiving, from the UE, the L2 SDU in the first PUSCH resource, wherein the retransmission of the L2 HARQ indication is received in a second PUSCH resource.

30. The method of claim 27, further comprising:
transmitting, to the UE, retransmission downlink control information (DCI) that grants a first physical uplink shared channel (PUSCH) resource for a retransmission of an L2 service data unit (SDU); and
receiving, from the UE, the L2 SDU in a second PUSCH resource, wherein the retransmission of the L2 HARQ indication is received in the first PUSCH resource.
